(19) United States
(12) Patent Application Publication
(10) Pub. No.: US 2026/0002773 A1
(43) Pub. Date: Jan. 1, 2026

(54) Multibeam optical lever profiler

(71) Applicant: Wojciech Jan Walecki, SUNRISE, FL (US)

(72) Inventor: Wojciech Jan Walecki, SUNRISE, FL (US)

(21) Appl. No.: 18/759,901

(22) Filed: Jun. 30, 2024

(51) Int. Cl. G01B 11/25

(52) U.S. Cl. CPC G01B 11/254

(57) ABSTRACT

We present a novel optical lever surface slope metrology tool employing a plurality of optical beams converging and crossing at the point close to the measured surface. The system increases the range and accuracy of the measurement.

### DESCRIPTIONS OF THE DRAWINGS

FIG. 1: Optical path in the optical lever device 199 for slope measurement. The light source 109 is emitting the optical beam 101. Optical beam 101 impinges the surface of sample 1 at an angle α to normal 10 to surface 1. The optical beam 101 produces reflected beam 102 impinging position detector 1000 at a point at the distance x from the intersection of the detector 1000 and normal 10. The position of point x depends on the slope a of sample 10 and the location L of the surface.

FIG. 2: shows the optical path in the optical lever device when surface 1 is shifted by distance H and the shifted surface is denoted surface 2. When resulting surface 2 is shifted by distance H with regards to surface 1 then it produces reflected beam 103 which is impinging position sensing detector 1000 in point x+δx shifted by the additional distance δx.

FIG. 3: shows the optical path in the optical lever device when surface 1 was displaced by distance H2 and tilted by angle (which results in the reflected beam 104 impinging detector 1000 at a point at the same distance x as in FIG. 1 when β=α, and H2=0.

FIG. 4: The arrangement using beamsplitter and allowing the optical beam to impinge the wafer at a normal angle, where 91 is a light source, 92 light beam conditioning optics, 903 beamsplitter, 1 measured sample surface, and position light beam detector 1000.

FIG. 5: The arrangement using a beamsplitter and allowing the optical beam to impinge the wafer at a normal angle, where 91 is a light source, 92 is a light beam conditioning optics, 903 is the beamsplitter, 904 is a lens conditioning optical beam, 1 measured sample surface, and position light beam detector 1000.

FIG. 6: The arrangement using beamsplitter and allowing the optical beam to impinge the wafer at a normal angle, where 91 is a light source, 92 light beam conditioning optics, 903 beamsplitter, 94 light conditioning optics, 1 measured sample surface, and position light beam detector 1000.

FIG. 7: Optical lever profiler based on XYZ stages. The optical profiler 199 is attached to mounting beam 206. The optical profiler 199 is connected to electrical controller 216 by cable harness 205. Mounting beam 206 is connected to instrument stand 203. The optical lever device is connected by an electrical or optical cable harness 205 to an electronic controller unit 216. The electrical controller 206 unit is in electrical or radio communication with the computer 217. The measured surface 1 resides on a sample holder 204. The sample holder 204 is residing on motion table 214. The position of the motion table 214 is controlled by XY motorized stage 201, and Z stage motorized stage 202.

FIG. 8: Optical lever profiler based on R-Theta and Z stages. The optical profiler 199 is attached to motorized R motion table 212. The motorized motion table 212 is moving along mounting rail 207. The optical profiler 199 is connected to electrical controller 216 by cable harness 205. Mounting beam 206 is connected to instrument stand 203. The optical lever device is connected by an electrical or optical cable harness 205 to an electronic controller unit 216. The electrical controller 206 unit is in electrical or radio communication with the computer 217. The measured surface 1 resides on a sample holder 204. The sample holder 204 is residing on motion table 214. The position of the motion table 214 is controlled by Theta rotation motorized stage 211, and Z motorized stage 202.

FIG. 9: Optical arrangement of the optical beams 2010, 2011, and 2012 produced by optical sources 2000, 2001, and 2002 respectively, and converging in one point in 2D (two dimensional) optical lever system. This drawing illustrates projection on the xz plane.

FIG. 10: The same optical arrangement as shown in FIG. 9, where this drawing illustrates projection on the yz plane.

FIG. 11: Optical arrangement of the optical beams 2010, 2011, 2012, 2013, and 2014 produced by optical sources 2000, 2001, 2002, 2003, and 2004 respectively, and converging in one point in 3D (two dimensional) optical lever system. The drawing illustrates the projection on the xz plane.

FIG. 12: The same optical arrangement as shown in FIG. 11. This drawing illustrates the projection on the yz plane.

FIG. 13: The outline of the system is shown in FIG. 11. The system may employ a plurality of in preference single mode fiber coupled laser 7201, and 7202 connected with the single mode optical fibers to fiber coupler 7206. The fiber coupler is connected using optical fiber to beam forming assembly emitting free space optical beam 7209 towards the 2D grating which may or may not be equipped with an additional lens 7210. The 2D grating produces a three-dimensional fan of optical beams 7221-7225, where only five examples of such rays are shown. In practice, we expect to generate about 100 such rays. The 3D fan of beams is conditioned by lens system 7230-7250 and focused on a single point on the surface of sample 1. The beams reflected from sample 1 are used to triangulate the position of sample 1 and are used to both measure its slope in 3 dimensions the distance from the source to sample 1. Only a few of the multiple beams 7221-7225 will impinge the Beam Detector. To identify which optical beams “hit” the detector we can simply change the wavelengths of these beams by turning on and off some of the laser sources (represented in this picture by boxes 7201, 7202.) Since the different wavelengths are diffracted by 2D grating in usually different directions only one chief ray beam always propagates the same direction for two different wavelengths. This allows us to identify the chief ray beam. Other beams are also diffracted at varying angles and can be identified by varying wavelengths.

FIG. 14: Geometry of beams reflected from the sample 1000 for 2D lever device 2010, 2011, 2012 impinging beam detector 1000 discussed in Appendix A.

FIG. 15: Optical beams impinging beam detector 1000 for the flat sample mounted in plane xy and shown in FIG. 11. Beam 2010 impinges at a point marked by a solid circle, beam 2011 impinges at a point marked by a solid square, beam 2012 impinges beam detector at a point marked by an empty square, beam 2013 impinges at a point marked by a solid diamond, beam 2014 impinges beam detector at a point marked by an empty diamond, Point where beams 2000-2014 cross each other is located at distance H from the plane of detector 1000. The optical path length between sample 1 and the plane of detector 1000 is H=250 mm. Other parameters used in our simulation are h=0.0 mm, ax=0.00 rad, ay =0.00 rad. Where h is the distance between the crossing point of optical beams and sample 1, and ax, ay are x and y components of the vector normal to sample 1. Points were generated by the simulation described below.

FIG. 16: Same as FIG. 15 but the parameters used in our simulation are h=−50.0 mm, ax=0.00 rad, ay=0.00 rad. Where h is the distance between the crossing point of optical beams and sample 1, and ax, ay are x and y components of the vector normal to sample 1.

FIG. 17: Same as FIG. 15 but the parameters used in our simulation are h=50.0 mm, ax=0.00 rad, ay=0.00 rad. Where h is the distance between the crossing point of optical beams and sample 1, and ax, ay are x and y components of the vector normal to sample 1.

FIG. 18: Same as FIG. 15 but the parameters used in our simulation are h=0.0 mm, ax=0.01 rad, ay=0.00 rad. Where h is the distance between the crossing point of optical beams and sample 1, and ax, ay are x and y components of the vector normal to sample 1.

FIG. 19: Same as FIG. 15 but the parameters used in our simulation are h=0.0 mm, ax=−0.01 rad, ay=0.00 rad. Where h is the distance between the crossing point of optical beams and sample 1, and ax, ay are x and y components of the vector normal to sample 1.

FIG. 20: Same as FIG. 15 but the parameters used in our simulation are h=0.0 mm, ax=0.00 rad, ay=0.01 rad. Where h is the distance between the crossing point of optical beams and sample 1, and ax, ay are x and y components of the vector normal to sample 1.

FIG. 21: Same as FIG. 15 but the parameters used in our simulation are h=0.0 mm, ax=0.00 rad, ay=−0.01 rad. Where h is the distance between the crossing point of optical beams and sample 1, and ax, ay are x and y components of the vector normal to sample 1.

FIG. 22: Same as FIG. 15 but the parameters used in our simulation are h=−25.0 mm, ax=−0.01 rad, ay=−0.01 rad. Where h is the distance between the crossing point of optical beams and sample 1, and ax, ay are x and y components of the vector normal to sample 1.

FIG. 23: Same as FIG. 15 but the parameters used in our simulation are h=0.0 mm, ax=−0.01 rad, ay=−0.01 rad. Where h is the distance between the crossing point of optical beams and sample 1, and ax, ay are x and y components of the vector normal to sample 1.

FIG. 24: Same as FIG. 15 but the parameters used in our simulation are h=−25.0 mm, ax=−0.01 rad, ay=−0.01 rad. Where h is the distance between the crossing point of optical beams and sample 1, and ax, ay are x and y components of the vector normal to sample 1.

FIG. 25: Algorithm for finding coefficients ax, ay. In the step measured positions points where beam 2010 impinges at a point marked by a solid circle, beam 2011 impinges at a point marked by a solid square, beam 2012 impinges beam detector at a point marked by an empty square, beam 2013 impinges at a point marked by a solid diamond, beam 2014 impinges beam detector at a point marked by an empty diamond are analyzed and initial rough values of parameters h, ax, ay are found. These parameters are used as starting fitting parameters for nonlinear minimizing error function defined by Equations 18-20.

FIG. 26: Results of the fit for parameters H=250.0 mm, h=−1.0 mm, delta=0.01 rad, ax=−0.01 rad, ay=−0.03 rad. Stdev of the single measurement was calculated using a sample of N measurements using data simulated using an equation where to each of coordinates x, y of each point of the pattern was added random noise having sigma given in the table.

FIG. 27: Procedure for calculation of parameters h, ax, and ay of the measured surface.

### OPTICAL LEVER

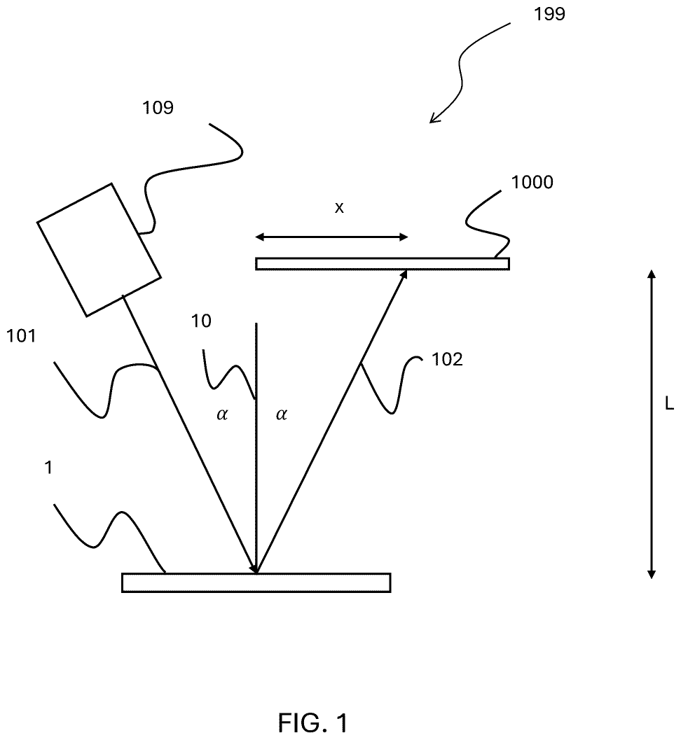

Optical lever is a device for measurement of the angle of a specular optical surface shown schematically as assembly 199 in FIG. 1. The optical beam probes surface 1 and the resulting reflected beam is detected at point x by the position sensing detector 1000. The optical beam may be produced by a laser or a point source equipped with a collimator. Position sensing detector (PSD) may be implemented as an Array detector or fragmented position detector mounted on a motion stage.

In 3D optical levers, the optical detector 1000 usually has a flat light-detecting surface. Usually, detector 1000 has a surface approximately perpendicular to impinging its beam.

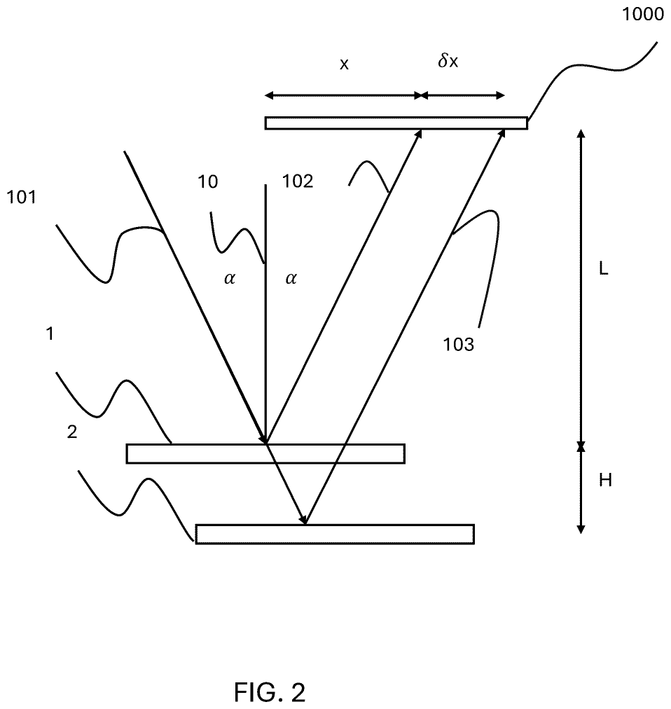

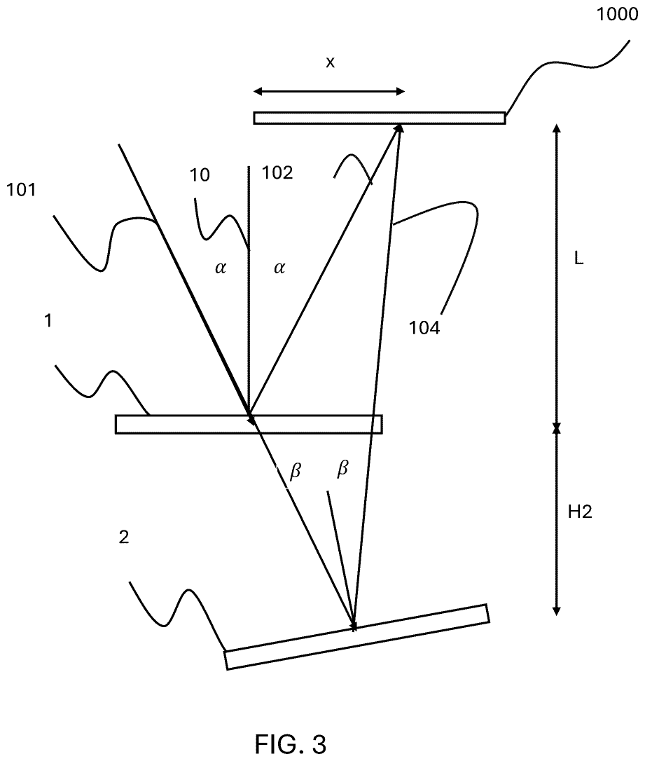

Immediately from FIG. 2 a person skilled in art notices the measurement result is sensitive to sample location. This correction was not considered in the standard tools [1,2]. One can estimate the error caused by the changing distance between detector 1000 and sample 1 (parameter H in FIGS. 2, and H2 in FIG. 3.

Directly from FIGS. 2(a) and 2(b) we see that the system is sensitive to the small changes of the distance sample and the array detector. When sample S is shifted (without changing its zero slope by the distance H the position spot projected on the Array detector is shifted by δx. Directly from FIG. 2 we get:

$$δ x = 2 H tan α \qquad ( 1 )$$

At the same for small angles α, and slopes close to zero we will have the error of the angle of the beam impinging detector of the order of

$$\frac{δ x}{L} = \frac{2 H}{L} tan α .$$

This implies that the error of the measurement of the slope of sample 1 is about

$$\frac{H}{L} tan α .$$

For the case of commercial tools where H=1 mm, L=30 cm, and α=3 deg we get an error of slope measurements of the order of 170 μrad. Which is not suitable for semiconductor and x-ray mirror applications which typically demand an accuracy of 1 μrad.

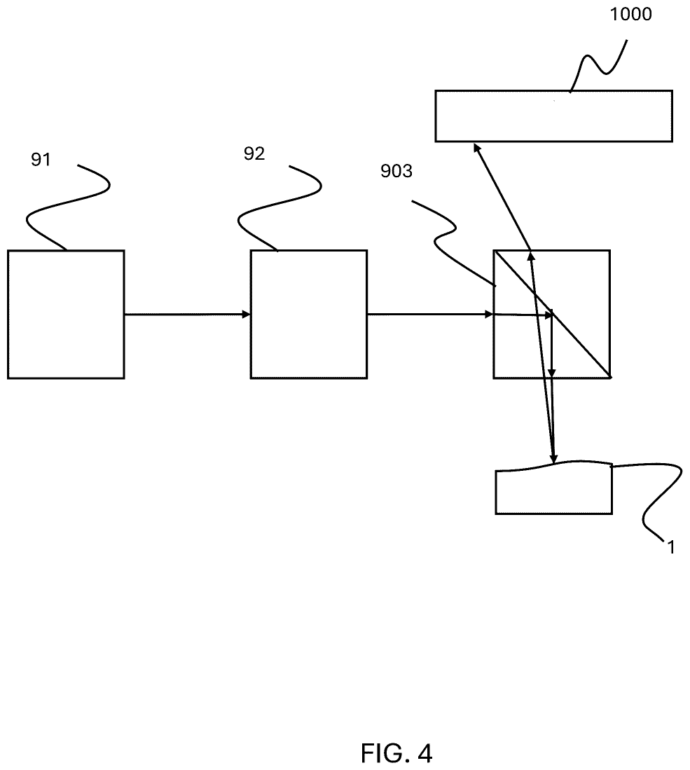

Directly from Equation (1) we see that we can reduce the error for very small slope measurements by decreasing the angle α. Setting simply α=0 as shown in FIG. 3 is possible but requires the use of additional beam splitters [3] as shown in FIG. 4 below.

### Optical Lever Profilers

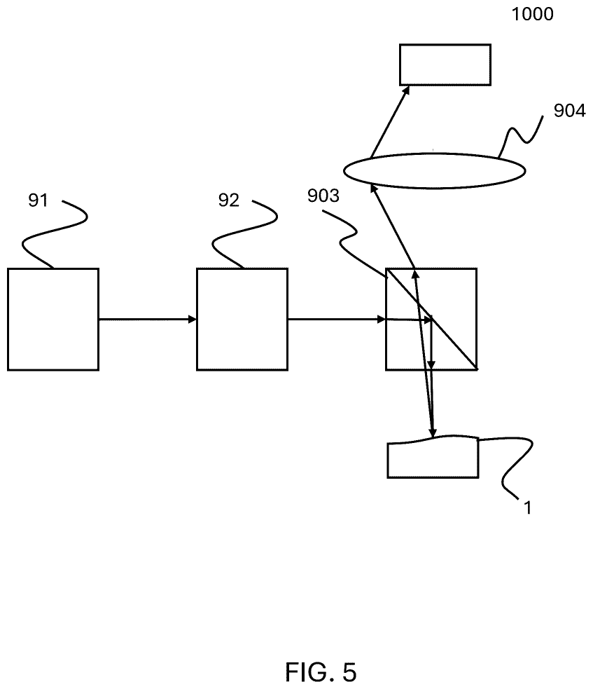

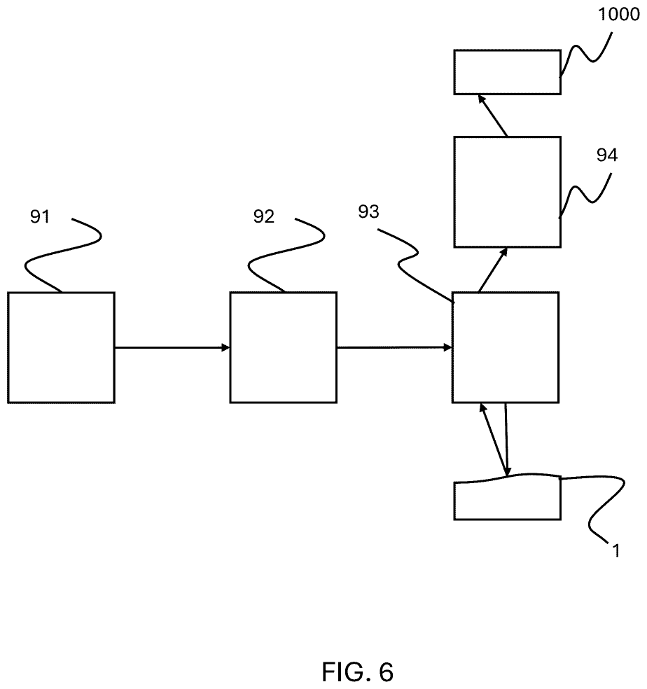

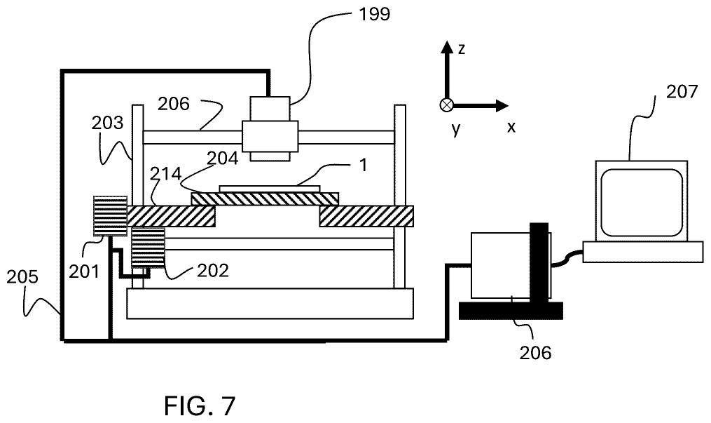

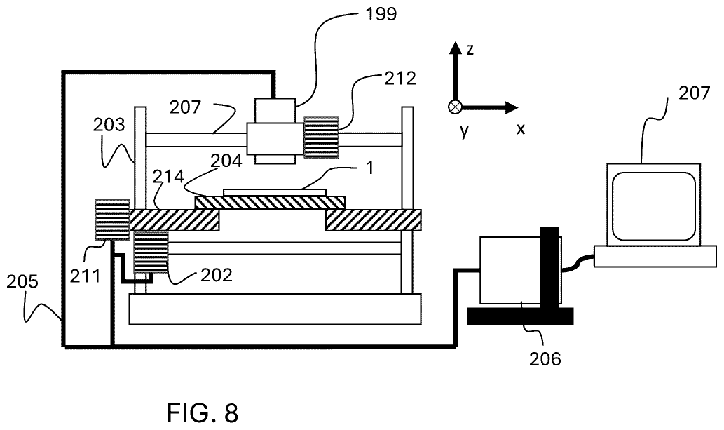

Three dimensional (3D) optical lever profiler comprises an optical lever device and 3D positioning stage. The 3D positioning stage may be XYZ stage shown in FIG. 5 where one of the axes (usually Z) is oriented in the direction normal to the plane of the flat light detecting surface 1000, or the R-Theta-Z stage as shown in FIG. 6. Again, the Z-axis is oriented in the direction normal to the plane of the flat light detecting surface 1000.

2D Optical profiler has a construction similar to this of 3D optical profiler shown in FIG. 5 where the XY actuator 202 is replaced by the 1D (1-dimensional) actuator moving stage 214 only in one direction (X either Y).

### Limitations and What is the Main Idea of the Invention

The simple 2D and 3D optical profilers have several important limitations.

The first limitation, as discussed above and shown in FIGS. 2 and 3 is the dependence of the position of optical spot x on the position of the sample as shown in Equation 1, and denoted by H, and H2 parameters in FIGS. 2 and 3 respectively.

The second limitation is a limitation of the range of measured angle α in FIG. 1. This limitation results from the finite length of the optical detector 1000. The lengths and widths of popular array detectors do not exceed 2 inches, while the size of popular PSD is not more than 4 inches. Some systems use discrete (so-called split) PSD mounted on a separate motion stage. This solution suffers from a speed limitation due to the time needed to move the discrete split detector along the mechanical motion stage.

### Multibeam Profiler

I will define the length of the optical lever as the length of the optical path between the sample and the beam detector.

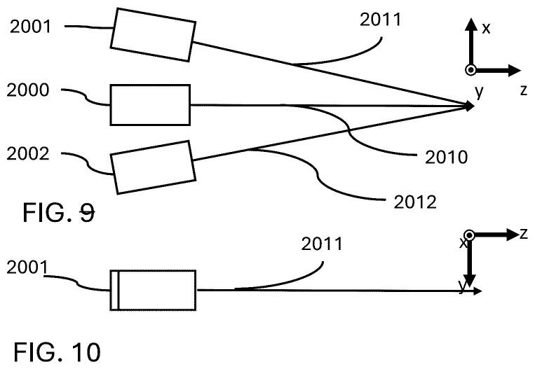

To avoid the limitations of the optical lever method I invented a system employing a set of convergent beams. Multiple beams shown in FIGS. 9, 10, 11, 12, and 13 extend the range over which the optical lever measurement. They also allow us to estimate the position of the sample using the triangulation method and to reduce errors caused by the displacement of the sample along the z-axis shown in FIGS. 9,10,11, and 12.

A person skilled in art will notice that using this device one may use more than one probe beam to create an optical lever. The main advantage of this invention is that when the measured surface deflects the first probing beam outside the beam detector one may use another beam that impinges the beam detector to find the slope of the surface. The plurality of converging beams allows one to use as an optical lever only these beams which still impinge beam detector.

The use of multibeam illumination extends range and does not affect measurement accuracy. The alternative, existing method of extending the range of the slope of the sample measurement involves shortening the length of the optical lever. The measurement accuracy and resolution decrease in proportion to the optical lever length.

The plurality of the beams can be produced using various methods. The method uses of a plurality of sources as shown in 2D and 3D cases in FIGS. 9,10,11, and 12 respectively. For the person familiar with the art, it is obvious that the scheme shown in FIGS. 9,10,11, and 12 can be extended to systems producing more converging beams, using multiple light sources or by splitting light into a plurality of beams using free space or fiber optic beamsplitters and patch cables, relay optics or other beam delivery components.

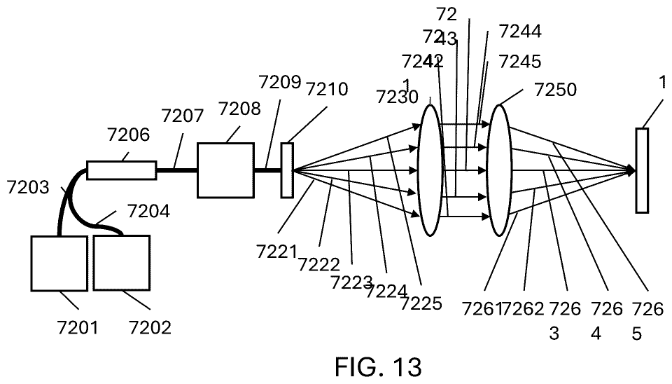

The other method employs a diffraction grating to produce a fan of optical beams as shown in FIG. 13. Directions of all diffracted monochromatic beams can be measured or calculated using grating equations.

The multi-beam optical lever profilers may be operated in configurations with beamsplitters and configurations without beamsplitters 903 like the configurations shown in FIGS. 1 and 2.

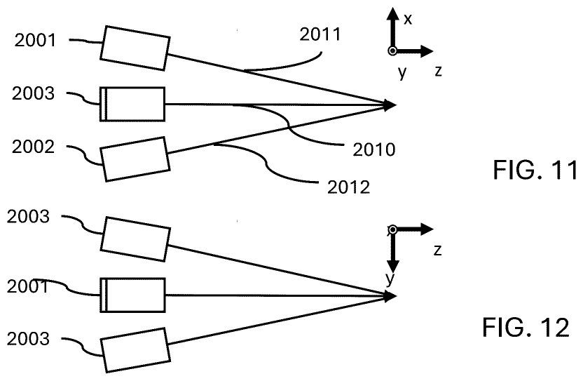

Below we will calculate the pattern formed by a fan of multiple beams impinging beam detector 1000 for the five optical beams shown in FIGS. 11 and 12. A person skilled in art will notice that similar calculations with minor modifications can be repeated for the system shown in FIG. 13.

The solution for 2D case of three beams is shown in Appendix A.
///**** finished here

### Finding Normal to the Surface for 3D System

In these calculations, we will assume that the measured surface is flat in the proximity of the probing beams. This assumption is justified since the tool is intended to measure wafers and X-ray mirrors having curvature in the range 10 m-10 km.

We will select a local system of coordinates such that its origin sits at the intersection of the axis Z and plane of the flat sample 1. The sample is illuminated by a fan the beams having the following directions:

The central beam propagates in the direction

$$\vec{{S}_{c}} = [ \begin{matrix}0 \\ 0 \\ 1\end{matrix} ] \qquad Equation 1$$

Two beams displaced along x (for positive and negative values of angle δ which we will set to ±δ) have directions:

$$\vec{{S}_{x}} = [ \begin{matrix}sin δ \\ 0 \\ cos δ\end{matrix} ] \qquad Equation 2$$

Two beams displaced along y by ±δ having directions:

$$\pm \vec{{S}_{y}} = \pm [ \begin{matrix}0 \\ sin δ \\ cos δ\end{matrix} ] \qquad Equation 3$$

All five beams described above cross at a point located on z axis when the sample is removed. This point is located at distance h measured long z-axis from the plane of sample 1. It may be located above or below the plane of sample 1.

$${F}^{′} = ( \begin{matrix}0 \\ 0 \\ h\end{matrix} ) \qquad Equation 4$$

Sample 1 surface contains the origin, and the normal unit vector to plane 1 has coordinates:

$$\hat{a} = [ \begin{matrix}{\hat{a}}_{x} \\ {\hat{a}}_{y} \\ {\hat{a}}_{y}\end{matrix} ] \qquad Equation 5$$

The operator of the reflection in the plane of sample 1 has form:

$${R}_{i , j} = {δ}_{i , j} - 2 \frac{‖ a ‖}{} \qquad Equation 6$$

Using Equation 4 and 6 we find the image of a point F′ in the plane of the sample 1:

$$\tilde{{F}^{′}} = ( \begin{matrix}0 \\ 0 \\ h\end{matrix} ) - 2 ( \begin{matrix}{\hat{a}}_{x} {\hat{a}}_{z} h \\ {\hat{a}}_{y} {\hat{a}}_{z} h \\ {\hat{a}}_{z} {\hat{a}}_{z} h\end{matrix} ) \qquad Equation 7$$

The rays propagating towards the detector 1000 have directions

$$= \vec{{S}_{c}} - 2 ( a \cdot \vec{{S}_{c}} ) \hat{a} \qquad Equation 8$$

$$= \vec{{S}_{x}} - 2 ( \hat{a} \cdot \vec{{S}_{x}} ) \hat{a} \qquad Equation 9$$

$$= \vec{{S}_{y}} - 2 ( \hat{a} \cdot \vec{{S}_{y}} ) \hat{a} \qquad Equation 10$$

The parametric equation for these five rays (please remember that we use both positive and negative angles ±δ have form:

$${L}_{c} = \cdot t + \tilde{F} \qquad Equation 11$$

$${L}_{x} = \cdot u + \tilde{F} \qquad Equation 12$$

$${L}_{y} = \cdot v + \tilde{F} \qquad Equation 13$$

where t, u, v are parameters.

Using Equations 11-13 we find points in which each of the rays impinges screen located in z=−H plane. First, we will consider the central ray. For this ray, we have the detector plane:

$${( \cdot t + \tilde{F} )}_{z} = - H \qquad Equation 14$$

From Equation 14 we get:

$$t = \frac{- H - {\tilde{F}}_{z}}{{\tilde{S}}_{{c}_{z}}} \qquad Equation 15$$

Similarly for other rays we get

$$u = \frac{- H - {\tilde{F}}_{z}}{{\tilde{S}}_{{c}_{x}}} \qquad Equation 16$$

$$and v = \frac{- H - {\tilde{F}}_{z}}{{\tilde{S}}_{{c}_{y}}} \qquad Equation 17$$

Using Equations 11-13 and Equations 15-17 we can find points where central beam C and, other four beams (two deflected in x direction X before impinging sample 1, and two deflected in y direction Y before impinging sample 1) impinge screen mounted at z=−H. These five points will form a set later called “a pattern”. The pattern will be used to calculate the values of h, and âₓ, â_{y}.

$$C = ( \begin{matrix}- 2 {\hat{a}}_{z} {\hat{a}}_{x} \frac{- H + h}{1 - 2 {\hat{a}}_{z} {\hat{a}}_{z}} \\ - 2 {\hat{a}}_{z} \hat{{a}_{y}} \frac{- H + h}{1 - 2 {\hat{a}}_{z} {\hat{a}}_{z}}\end{matrix} ) \qquad Equation 18$$

$$X = ( \begin{matrix}( sin δ - 2 ( {\hat{a}}_{x} sin δ + {\hat{a}}_{z} cos δ ) {\hat{a}}_{x} ) \frac{- H + 2 {\hat{a}}_{z} {\hat{a}}_{z} h}{cos δ - 2 ( {\hat{a}}_{x} sin δ + {\hat{a}}_{z} cos δ ) {\hat{a}}_{z}} - 2 {\hat{a}}_{x} {\hat{a}}_{z} h \\ - 2 {\hat{a}}_{y} \hat{{a}_{z}}\end{matrix} ) \qquad Equation 19$$

$$Y = ( \begin{matrix}- 2 ( {\hat{a}}_{y} sin δ + {\hat{a}}_{z} cos δ ) {\hat{a}}_{x} ) \frac{- H + 2 {\hat{a}}_{z} {\hat{a}}_{z} h}{cos δ - 2 ( {\hat{a}}_{y} sin δ + {\hat{a}}_{z} cos δ ) {\hat{a}}_{z}} - 2 {\hat{a}}_{x} {\hat{a}}_{z} h \\ ( sin δ - 2 ( {\hat{a}}_{y} sin δ + {\hat{a}}_{z} cos δ ) {\hat{a}}_{y} ) \frac{- H + 2 {\hat{a}}_{z} {\hat{a}}_{z} h}{cos δ - 2 ( {\hat{a}}_{y} sin δ + {\hat{a}}_{z} cos δ ) {\hat{a}}_{z}} - 2 {\hat{a}}_{y} {\hat{a}}_{z} h\end{matrix} ) \qquad Equation 20$$

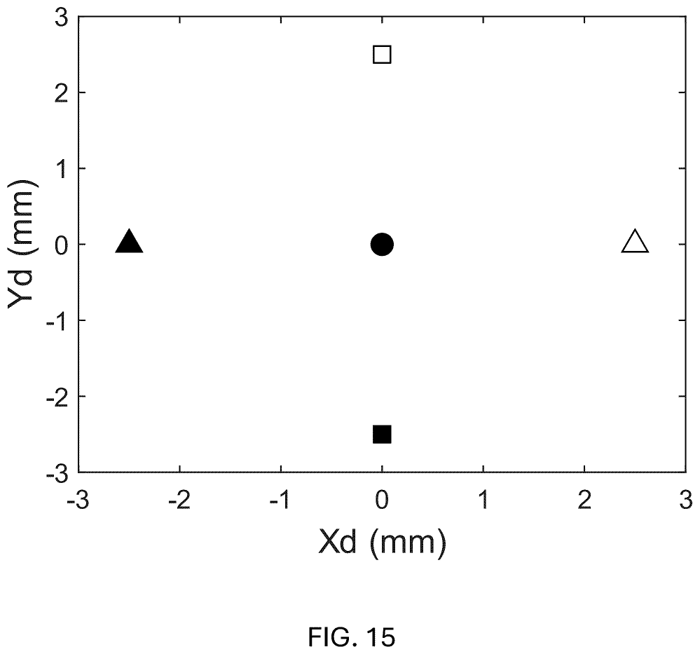

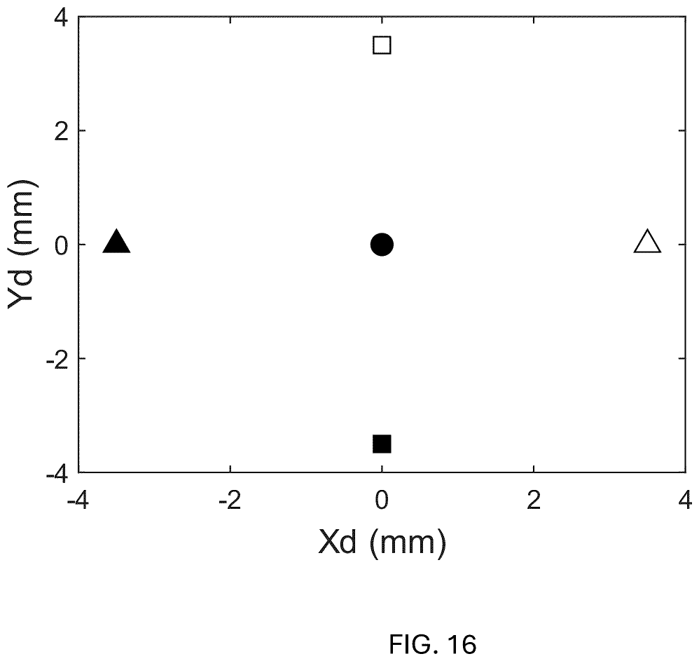

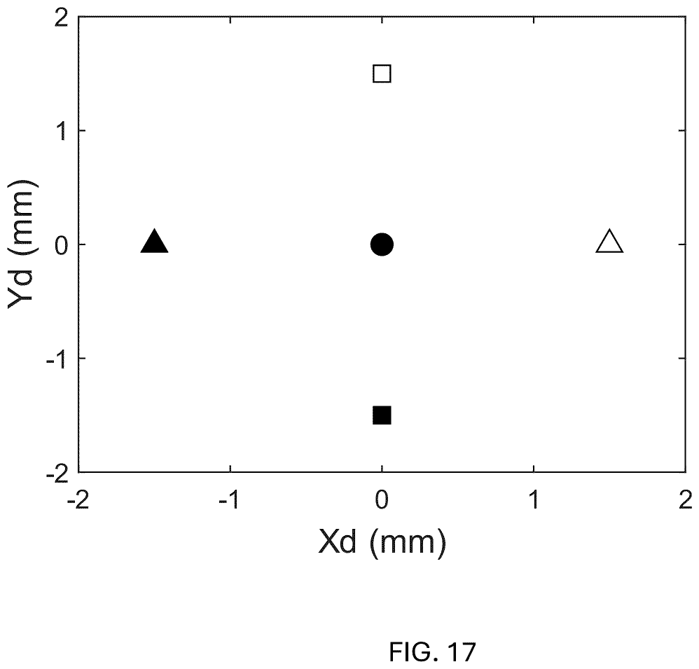

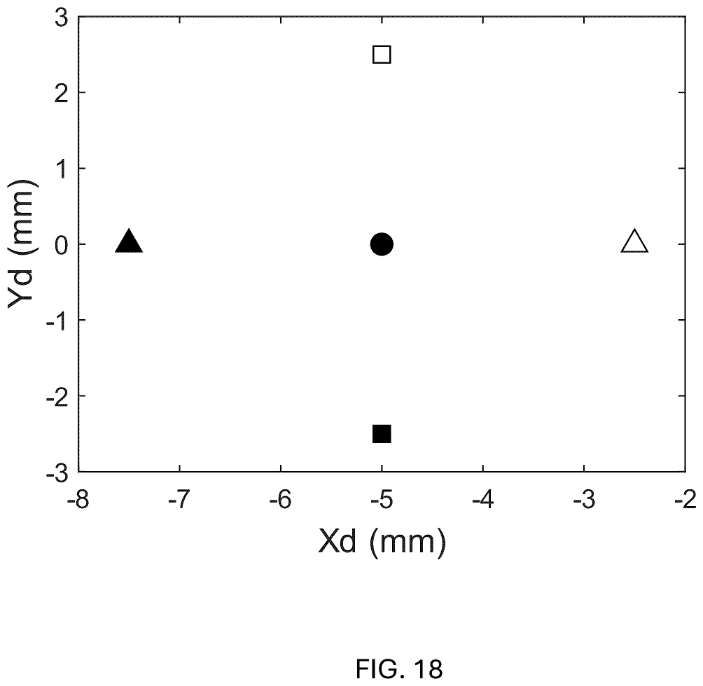

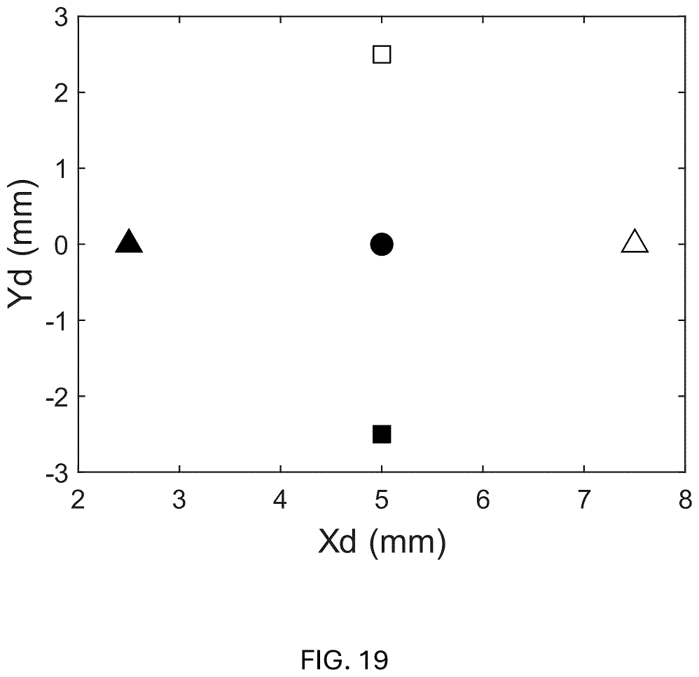

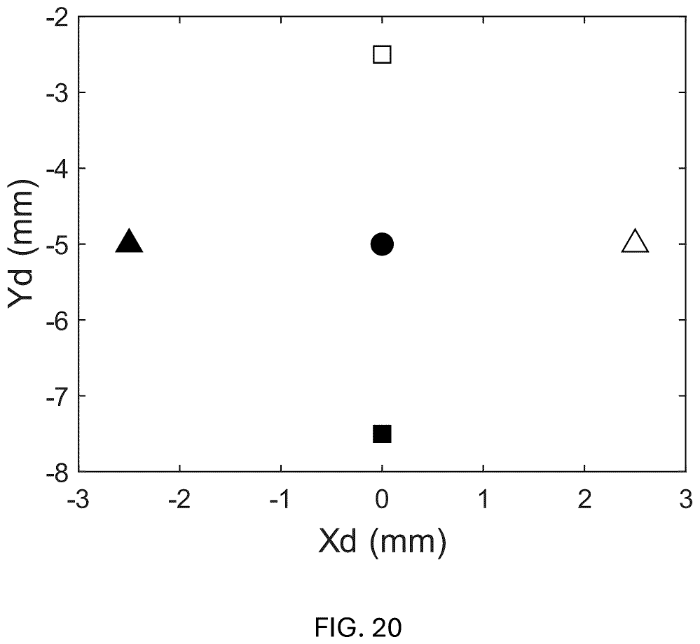

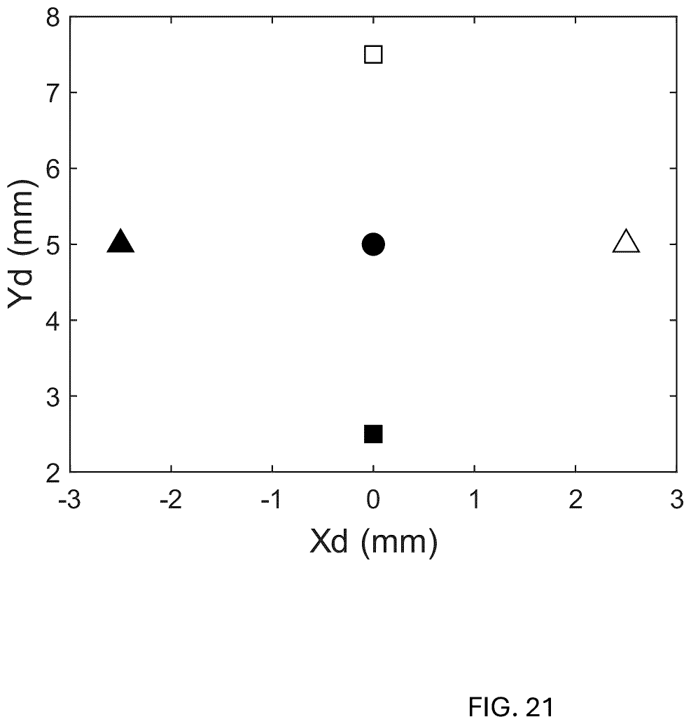

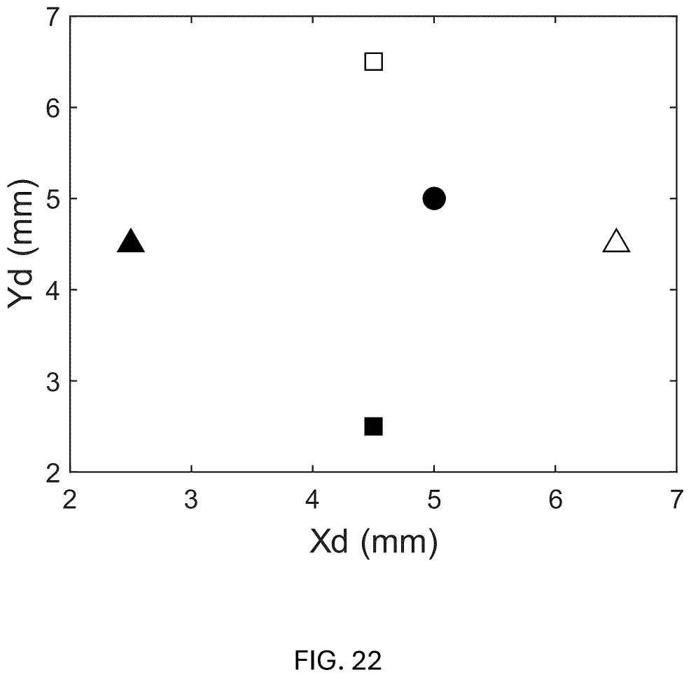

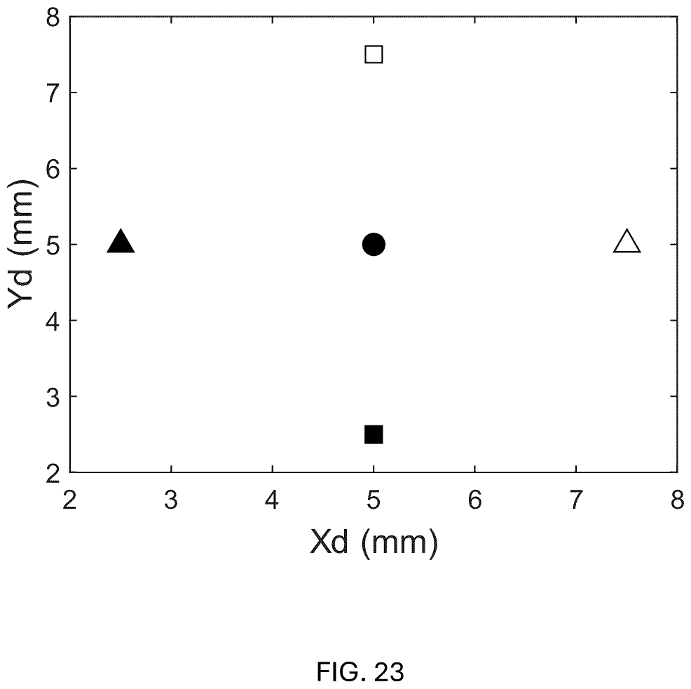

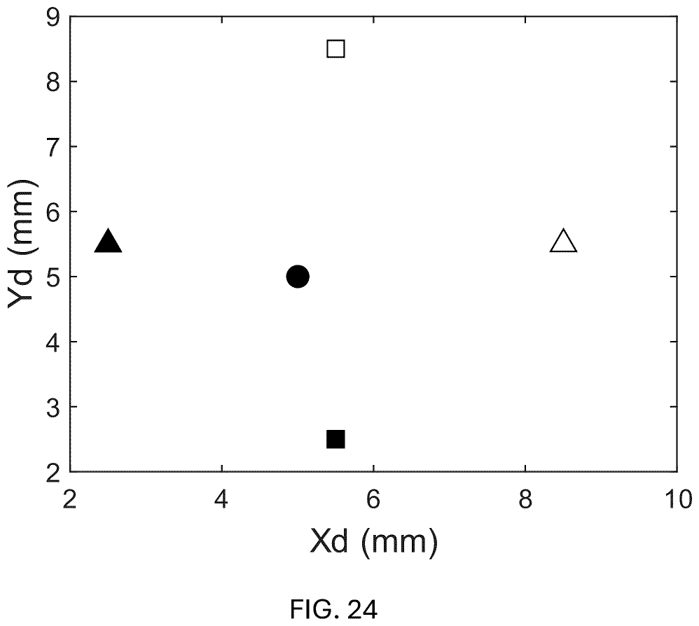

Patterns corresponding to various values of h, and âₓ, â_{y} are shown in FIGS. 15-24.

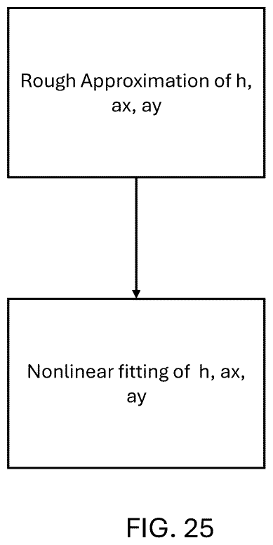

One can use the relationships given in the Equations 18-20 to find sample parameters h, and âₓ, â_{y} from the position of pattern points, as it is shown in FIG. 25. This calculation we perform in two steps. First, we find a rough approximation to ax, ay by measuring the average position of the pattern and pattern magnification which provides us with an estimate of h. When the sample changes position by value h the optical path from, the image \tilde{F} to detector changes by H+2h, and the pattern becomes magnified by the factor

$$\frac{H + 2 h}{H} .$$

Measurement of the magnification provides a rough approximation of h. In the second step, we use nonlinear fitting to match the calculated and observed positions of the points belonging to the Pattern using a standard non-linear fitting procedure minimizing an error function. The error function ε is the usual sum of squares of errors between measured X, Y, and Cpatternpoints and calculated patterns using Equations 17-20.

$$ε ( h , {\hat{a}}_{x} , {\hat{a}}_{y} ) = {\sum }_{Δ = - δ , + δ} [ {( {Xmeasured}_{Δ} - {X}_{Δ} )}^{2} + {( {Ymeasured}_{Δ} - {Y}_{Δ} )}^{2} ] + {( Cmeasured - C )}^{2}$$

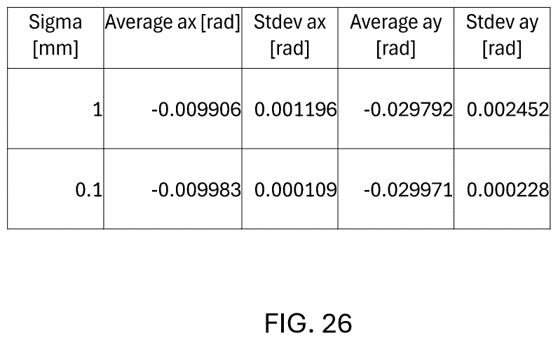

I have performed such fit calculations on simulated pattern points using varying degree of normal noise affecting both x, y coordinates in the same way, and where the width of the distribution of generated points was as it is presented in the Table in FIG. 26. As we see the calculation recovered values of âₓ, â_{y} used in our simulation.

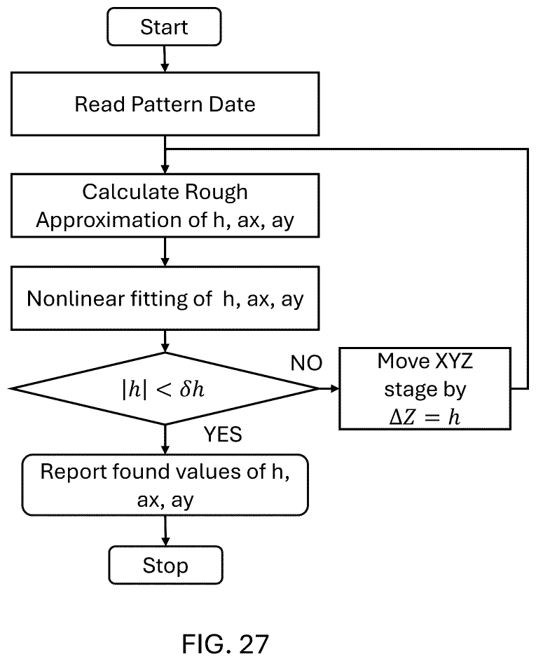

Equations 18-20 were derived when assuming that sample 1 was approximately flat. This approximation becomes better when h=0 (where the image \tilde{F}′ sits on the surface of sample 1). We can use the procedure described in FIG. 27 to move the sample arbitrarily close (δh) to image point \tilde{F}′. This method can be used for highly curved samples.

### Appendix A

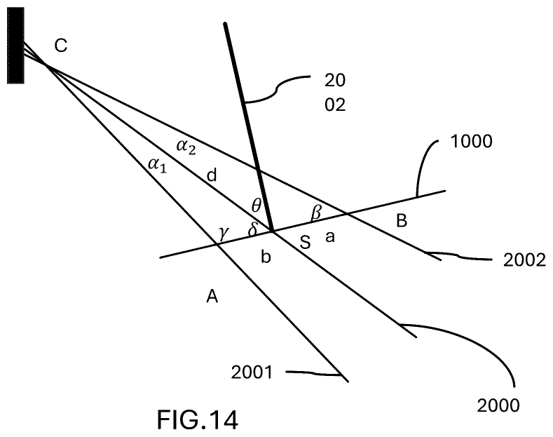

We will examine FIG. 14.

From law of sines for the triangles ΔASC and ΔBSC we get the following:

$$\frac{b}{sin α} = \frac{d}{sin γ} and \qquad Equation A 1$$

$$\frac{a}{sin α} = \frac{d}{sin β} \qquad Equation A 2$$

By dividing side by side of Equation (1) by Equation (2) we get

$$\frac{b}{a} = \frac{sin β}{sin γ} \qquad Equation A 3$$

By inspecting the sum of all angles in the triangle ΔBCS we get:

$$β = π - α - ( π - δ ) \qquad Equation A 4$$

$$Or β = - α + δ \qquad Equation A5$$

By inspecting the sum of all angles in the triangle ΔASC we get:

$$γ = π - α - δ \qquad Equation A 6$$

From Equation (3), (5) and (6) we get:

$$\frac{b}{a} = \frac{sin ( δ - α )}{sin ( δ + α )} \qquad Equation A7$$

Using the formula for the sine of the sum

$$\frac{b}{a} = \frac{sin ( δ ) cos ( α ) - sin ( α ) cos ( δ )}{sin ( δ ) cos ( α ) + sin ( α ) cos ( δ )} \qquad Equation A8$$

By dividing Eq (8) numerator and denominator of Right Hand Side by cos (a) we get

$$\frac{b}{a} = \frac{sin ( δ ) - tan ( α ) cos ( δ )}{sin ( δ ) + tan ( α ) cos ( δ )} \qquad Equation A9$$

Directly from FIG. 1

$$\frac{b}{a} = \frac{sin ( \frac{π}{2} - θ ) - tan ( α ) cos ( \frac{π}{2} - θ )}{sin ( \frac{π}{2} - θ ) + tan ( α ) cos ( \frac{π}{2} - θ )} \qquad Equation A9a$$

$$\frac{b}{a} = \frac{cos ( θ ) - tan ( α ) sin ( θ )}{cos ( θ ) + tan ( α ) sin ( θ )} and \qquad Equation A10$$

$$\frac{b}{a} = \frac{1 - tan ( α ) tan ( θ )}{1 + tan ( α ) tan ( θ )} \qquad Equation A11$$

$$b + b tan ( α ) tan ( θ ) = a - a tan ( α ) tan ( θ ) \qquad Equation A12$$

$$tan ( θ ) = \frac{a - b}{( a + b ) tan ( α )} \qquad Equation A13$$

In principle this formula could be used to find the deflection angle. However, since the difference a−b is a usually very small and since 1/tan(α) is usually quite large and it does “amplify” the measurement errors this is not very accurate way of finding the deflection angle. It is more accurate to find it using position S on the array detector.

Now we will find the length of the bisector d as a function of known α, a, b alone. From [Amelia, Mashadi, and Sri Gemawati. “Alternative Proofs for the Length of Angle Bisectors Theorem on Triangle.” International Journal of Mathematics Trends and Technology 66 (2020): 163-166] we have using the notation from FIG. 14:

$${d}^{2} = \vert CA \vert \cdot \vert CB \vert - ab \qquad Equation A14$$

$$But using the law of sines$$

$$\frac{\vert CA \vert}{sin ( \frac{π}{2} - θ )} = \frac{b}{sin α} or \qquad Equation A15$$

$$\vert CA \vert = \frac{cos θ}{sin α} b \qquad Equation A16$$

$$Similarly$$

$$\frac{\vert CB \vert}{sin ( \frac{π}{2} + θ )} = \frac{a}{sin α} or \qquad Equation A17$$

$$\vert CB \vert = \frac{cos θ}{sin α} a \qquad Equation A18$$

From 14,16,18 we get length of the bisector.

$${d}^{2} = ab [ {( \frac{cos θ}{sin α} )}^{2} - 1 ] \qquad Equation A19$$

$${d}^{2} = ab [ \frac{1}{{( sin α )}^{2}} \cdot \frac{1}{1 + {( tan θ )}^{2}} - 1 ] \qquad Equation A20$$

From the equations (13) and (20) we see that if we measure a, b. and if we know the angle α we can find d.

1. Optical lever profilometer employing a plurality of optical beams having one common point and impinging measured surface at different angles and measuring the deflection angle of at least one of the reflected beams.

2. Optical lever profilometer as described in claim 1 and measurements of the pattern formed by beams impinging the array beam detectors and calculating the distance between the detector and normal to surface.

3. Optical lever profilometer as described in claim 1 where the plurality of the optical beams are coplanar and form 2 dimensional bundle of the beams converging to a single point and impinging measured surface at this point.

4. Optical lever profilometer as described in claim 1 where the plurality of beams propagating in two dimensions is produced using 1D optical grating

5. Optical lever profilometer as described in claim 3 where a plurality of beams propagating in the three dimensions is produced utilizing a 2D optical grating
